(19) United States
(12) Patent Application Publication
(10) Pub. No.: US 2026/0052550 A1
(43) Pub. Date: Feb. 19, 2026

(54) Terminal, System, and Method for Selecting Resources in Sidelink Communication Procedures

(71) Applicant: Apple Inc., Cupertino, CA (US)

(72) Inventors: Chunxuan Ye, San Diego, CA (US); Ankit Bhamri, Haar (IN); Chunhai Yao, Beijing (CN); Dawei Zhang, Saratoga, CA (US); Hong He, San Jose, CA (US); Huaning Niu, San Jose, CA (US); Oghenekome Oteri, San Diego, CA (US); Seyed Ali Akbar Fakoorian, San Diego, CA (US); Sigen Ye, San Diego, CA (US); Wei Zeng, Saratoga, CA (US)

(21) Appl. No.: 19/102,832

(22) PCT Filed: Aug. 12, 2022
(86) PCT No.: PCT/CN2022/112121

§ 371 Date: Feb. 10, 2025

(51) Int. Cl. H04W 72/25; H04L 1/1607; H04L 27/26

(52) U.S. Cl. CPC H04W 72/25; H04L 1/1614; H04L 27/2666

(57) ABSTRACT

A terminal may include a receiver configured to receive one or more SL transmissions. The terminal may include a processor configured to obtain parameters for a sidelink (SL) communication procedure that includes resources selected from a portion of an unlicensed spectrum. The processor may be configured to determine, based on the parameters, a resource selection pattern for an SL transmission. The processor may be configured to perform a resource selection procedure that includes resources selected from the portion of the unlicensed spectrum in accordance with the resource selection pattern.

### FIELD

The present application relates to wireless devices and wireless networks, including devices, circuits, and methods for performing Sidelink communication procedures.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

According to one or more embodiments, a terminal includes a receiver configured to receive one or more SL transmissions. The terminal includes a processor configured to obtain parameters for a sidelink (SL) communication procedure including resources selected from a portion of an unlicensed spectrum. The processor is configured to determine, based on the parameters, a resource selection pattern for an SL transmission. The processor is configured to perform a resource selection procedure including resources selected from the portion of the unlicensed spectrum in accordance with the resource selection pattern.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIG. 5 is a diagram illustrating an example of an intra-cell radio frame configuration, according to some aspects.

FIG. 6 is a diagram illustrating examples of radio frame configurations, according to some aspects.

FIGS. 7A and 7B are a flowcharts detailing methods of allocating resources in a Sidelink (SL) communication procedure, according to some aspects.

FIGS. 8A and 8B are diagrams illustrating examples of radio frame configurations, according to some aspects.

FIGS. 9A and 9B are diagrams illustrating examples of radio frame configurations, according to some aspects.

FIG. 10 illustrates an example SL communication signaling, according to some aspects.

FIGS. 11A and 11B are a flowcharts detailing methods of allocating resources in an SL communication procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate enabling Sidelink (SL) communication procedures, signaling, and resource selection for portions of an unlicensed spectrum in 5G/New Radio (NR) environments. Thus, disclosed herein are various solutions for performing and improving SL transmissions on portions of the unlicensed spectrum, including: 1) intra-cell guard band resource selection; 2) sub-channel resource indexing; 3) resource mapping for specific SL signals (e.g., DMRS, S-SSB, PSCCH, and PSSCH); and 4) multiple starting symbols within a slot for the specific SL signals.

In accordance with one or more embodiments, a user equipment (UE) device or terminal communicating with other terminals (other wireless communication devices, network devices, UE devices, and/or Base Station (BS) devices) may perform radio transmissions including SL communication procedures on portions of the unlicensed spectrum. The SL communication procedures may be configured to include one or more resource allocation procedures supported by radio interface operations between UE and BS (Uu). The Uu interface or link refers to the air interface between the UE and the Radio Access Network (RAN), while the sidelink interface refers to the interface between UEs. SL communications may include unicast communication from a UE device to a BS device or another UE device, as well as unicast or multicast communication from the BS device or the other UE device to the UE device. The first communication mode may include receiving a resource allocation configuration indicating a resource allocation pattern from a core network over the Uu link. The second communication mode may include receiving the resource allocation configuration from the other UE device in one or more resource pools over sidelink. The first communication mode and the second communication mode may be further defined in the same manner as resource allocation mode 1 and resource allocation mode 2 are respectively described in TS 38.300 of the 3GPP standard.

In some embodiments, the unlicensed spectrum are individual unlicensed bands in a bandwidth with a range between 4.1 gigahertz (GHz) and 7.125 GHz. For example, the unlicensed bands may be in the ranges between 5.150 GHz and 5.925 GHz and between 5.925 GHz and 7.125 GHz, which respectively correspond to NR bands n46 and n96/n102 of the Frequency Range (FR1) defined in TS 38.101 of the 3GPP standard.

In one or more embodiments, individual bandwidth parts (BWPs) may be configured to perform the SL transmissions. In some embodiments, an SL BWP is a contiguous set of physical resource blocks (PRBs) in an SL transmission, selected from a contiguous subset of common resource blocks (RBs) for a given numerology (μ) on a given carrier configured for an SL communication procedure. Each SL BWP may be defined for the given numerology (μ) in relation to a subcarrier spacing, a symbol duration, and/or a cyclic prefix (CP) length. A UE device may be configured with four SL BWP for downlink and uplink. One of the SL BWPs may be active for downlink or uplink at any point in time. The SL BWP may be preconfigured (e.g., configured from factory settings) or dynamically configured (e.g., configured from the core network via a BS device or a UE device) to include multiple SL resource pools. At least one SL resource pool may be preconfigured in accordance with an integer number of RB sets. The SL resource pool may be a predefined resource pool configured to include a sub-set of PRBs of one RB set. Further, the SL resource pool may be configured in relation to a sub-channel size and a number of sub-channels in the SL resource pool if the SL resource pool includes at least two adjacent RB sets.

In some embodiments, the SL resource pool may be configured to include two adjacent RB sets and some PRBs within an intra-cell guard band located in-between the two adjacent RB sets. To select resources in the PRBs within the intra-cell guard band, a predetermined configuration procedure may be implemented using a specific resource channel mapping (i.e., PSCCH or PSSCH) in which frequency resources are mapped in an SL resource pool configuration, or a specific resource sub-channel mapping in SL transmissions where sub-channels are supported. The specific resource channel mapping and/or the specific resource sub-channel mapping may include indexes for frequency resources selected in individual interlaces or individual RB sets of a slot.

Interlaces may use non-consecutive PRBs to meet occupancy channel bandwidth requirements (OCB), which may be driven by requirements for using licensed and/or unlicensed frequency bands. Two neighbor PRBs in an interlace may be separated by a predetermined number of PRBs. The resource selection pattern may be configured to provide an indication for allocating PRBs in interlaces. In some embodiments, up to 10 distinct interlaces within an RB set may be used.

The UE device may be configured to perform one or more SL transmissions as part of the SL communication procedure. The one or more SL transmissions may be transmissions (or reception of transmissions) following protocols in which the UE device selects resources in accordance with the indexed frequency resources.

The UE device may implement the SL communication procedure upon receiving instructions from one of its neighboring terminals or upon receiving approval from one of its neighboring terminals after requesting an initialization of the SL communication procedure. The UE device may coordinate the SL transmissions with terminals connected through multiple radio access technologies (RATs) (i.e., LTE-A, 5G NR, and the upcoming 6G).

In some embodiments, the UE device is configured to perform the SL transmissions without negatively impacting a user's experience. To achieve this, the UE device selects resources in the unlicensed spectrum without taking data integrity away from communication resources selected in the licensed spectrum of a same SL transmission. Successful selection of frequency resources in the unlicensed spectrum and the licensed spectrum in the same SL transmission may prevent data rate reductions, delay increases, or jitter. In this regard, the UE device obtains communication parameters that define reference information indicating resource selections for the SL communication procedure. The UE device may use the communication parameters to determine a resource selection pattern to be used in the SL transmission procedure.

The resource selection pattern may be determined based on parameters obtained for the SL transmission procedure. In one or more embodiments, the UE device identifies an SL resources pool including a set of SL resources for communicating directly with one or more additional terminals in the SL transmission procedure. The resource selection pattern may be determined based on the SL resources pool identified and/or may include resources selected for at least a portion of the set of SL resources in the SL resources pool. The SL resources pool may be an existing SL resources pool previously configured for the SL communication procedure and/or may be an independent SL resources pool selected specifically for the SL communication procedure.

The UE device may initiate the SL communication procedure by transmitting, to the neighboring terminal, a broadcasting signal, which may include terminal capability and at least one communication request. The terminal capability may be communication information regarding one or more transmission and reception capabilities of the UE device, while the communication request may include a request for a start of the communication procedure to the neighboring terminal.

As described above, the parameters may be received by the UE device from the neighboring terminal via an SL communication link. If the neighboring terminal is another UE device, the parameters may be obtained from the other UE device via additional communication links established with a core network. If the neighboring terminal is a base station, the parameters may be obtained from the base station via higher layer signaling (e.g., signaling received from upper layers using Radio Resource Control (RRC) messaging or medium Access Control (MAC) messaging in devices connected to the core network).

The following is a glossary of terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

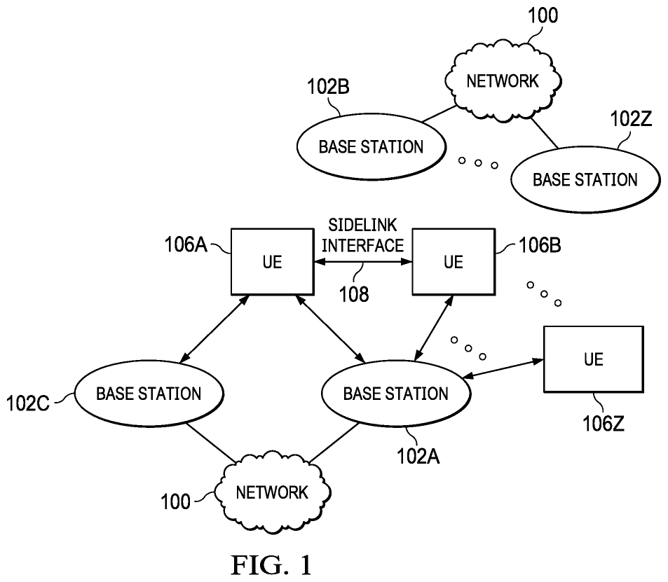

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Description of Sidelink (SL) Communication Links

In one or more embodiments, SL communication links are communication links established between terminals acting as UE devices. In SL communication links, each aforementioned physical channels corresponds to a set of resource elements carrying information originating from higher layers. These physical signals may include reference information signaling and synchronization information signaling. The reference information signaling may include reference information identifying at least one terminal a positioning reference using a reference signal (e.g., a demodulation reference signal). The positioning reference may be a terminal that is configured to obtain its absolute location on Earth or location within a specific area. The synchronization information signaling may include synchronization information relating to allocation of resources for at least one synchronization signal.

In one or more embodiments, two UE devices communicating with one another may exchange SL transmissions using the SL communication link. The SL communication link may be defined for 5G NR in TS 38.331 of the 3GPP standard.

The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

Examples of synchronization information may include communication information relating to selection of resources for at least one synchronization signal. A first option for the synchronization signal may be a Demodulation Reference Signal (DMRS) used for the PSCCH. In an Orthogonal Frequency Division Multiplexing (OFDM) symbol for the PSSCH, the synchronization signal may be the associated DMRS. A second option for the synchronization signal may be a DMRS for Demodulation Reference Signal (DMRS) used for the PSSCH. A third option for the synchronization signal may be a Phase Tracking Reference Signal (PTRS) configured to track phase changes and compensate phase noise during SL transmissions, which may be used for higher carrier frequencies. A time density and a frequency of the PTRS may be configured by the upper layers and may be configured per resource pool. A fourth option for the synchronization signal may be a Channel-State Information Reference Signal (CSI-RS). The CSI-RS may be used for channel sounding. The receiving device may measure the received CSI-RS, then may report back the CSI to the transmitter via the PSSCH. The CSI-RS may be configurable in both the time domain and frequency domain. The CSI-RS may be used to provide fine channel state information. A fifth option for the synchronization signal may be a Synchronization Signal (SS)/PSBCH Block. A slot that transmits the SS/PSBCH block may be referred to as a Sidelink Synchronization Signal Block (S-SSB). The SS/PSBCH block may include PSBCH, Sidelink Primary Synchronization Signal (SPSS) and Sidelink Secondary Synchronization Signal (SSSS) symbols. The period of the S-SSB transmission may be 16 frames, and within each period, the number of S-SSB blocks N in the S-SSB period is configured at the RRC. The range of choices for N may vary based on the numerology and the frequency range.

In one or more embodiments, the UE devices are configured to handle simultaneous sidelink and uplink/downlink transmissions. If any of the UE devices include limited reception capabilities in comparison to the rest of the UE devices, this UE device may prioritize sidelink communication reception, sidelink discovery reception on carriers configured by the eNodeB, and last sidelink discovery reception on carriers not configured by the gNB.

Sidelink transmissions may be organized into radio frames with a duration of T_{f}, each consisting of 20 slots of duration Tₛₗₒₜ. A sidelink subframe consists of two consecutive slots, starting with an even-numbered slot. A transmitted physical channel or signaling in a slot may be described by a resource grid corresponding to a first number of subcarriers and a second number of Single-Carrier (SC)-Frequency Division Multiple Access (FDMA) symbols.

In some embodiments, SL transmissions may be configured in accordance with a resource allocation pattern provided by the gNB. The resource allocation pattern may provide dynamic grants of sidelink resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by the UE device immediately, until these grants are released by RRC signaling. The UE device may be allowed to continue using this type of sidelink configured grants when beam failure or physical layer problems occur in NR access links (Uu) until a Radio Link Failure (RLF) detection timer expires, before falling back to an exception resource pool. Another type of sidelink configured grant may be a grant that is configured once and may not be used until the gNB sends the UE device a DCI indicating that the grant is now active, and until another DCI indicates deactivation.

In the sidelink configured grants, the resources are a set of sidelink resources recurring with a periodicity which the gNB matches resourced to those characterize for V2X traffic. Multiple configured grants can be configured, to allow provision for different services, traffic types, and the like. Modulation and Coding Scheme (MCS) information for dynamic and configured grants may be optionally provided or constrained by the RRC signaling instead of the DCI. The RRC may configure exact MCS the uses, or a range of MCSs. The MCS may also be left unconfigured. For the cases where the RRC does not provide the exact MCS, the UE device may be left to select an appropriate MCS itself based on any knowledge it may have of the transport block to be transmitted and sidelink radio conditions. The gNB scheduling activity may be driven by reporting in which the UE device shares its sidelink traffic characteristics to the gNB, or by performing a sidelink Buffer Status Report (BSR) procedure similar to that of the Uu to request the sidelink resource allocation from the gNB.

In some embodiments, the SL transmissions for the UE device may be configured in accordance with a self-selected resource allocation pattern (i.e., hereinafter referred to as resource selection pattern). The SL transmissions may be transmitted by the UE device a certain number of times after a resource selection pattern is selected, or until a cause of resource reselection is triggered. The SL transmissions may be performed to support unicast and groupcast communications in the physical layer. The SL transmissions may be configured to reserve resources to be used for a number of blind transmissions or HARQ-feedback-based transmissions of the transport block. The SL transmissions may be performed to select resources to be used for the initial transmission of a later transport block.

In one or more embodiments, the resource selection patterns selected for the SL transmissions may be implemented in SL Bandwidth Parts (BWP). SL BWP may be sets of contiguous resource blocks configured for the SL transmissions inside a predetermined channel bandwidth. The configuration of the SL BWP and SL resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the SL resource pools that are contained within it, namely a number of symbols and starting symbol used for SL in all slots (except those with Synchronization Signal Block (SSB)), power control for PSBCH, and a location of a Direct Current (DC) subcarrier.

The SL BWP may have different lists of SL resource pools for transmissions and receptions, to allow for the UE device to transmit in a pool and receive in another one. For transmissions, there may be one pool for a selected mode, one for a scheduled mode (e.g., when the gNodeB helps with resource selection), and one for exceptional situations. These SL resource pools may be expected to be used for only transmission or reception, except when SL feedback mechanisms are activated, in which case the UE device may transmit Acknowledgement (ACK) messages in a reception pool and receive ACK messages in a transmission pool.

In 5G NR technologies, the SL resource pool may be located inside an SL BWP is defined by a set of contiguous Resource Blocks (RBs) defined by the information element labeled sl-Rb-Number in the frequency domain starting at an RB defined by the information element labeled sl-StartRBsubchannel. Further, the SL resource pool may be divided into sub-channels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the SL resource pool may not be used by the UEs.

In the time domain, an SL resource pool has some available slots configured by various parameters. To determine which slots belong to the pool, a series of criteria may be applied. The slots where SSB is transmitted may not be used. The number and locations of those slots may be based on a predefined configuration. Slots that are not allocated for UL (e.g., in the case of Time Division Multiplexing (TDD)) or do not have all the symbols available (as per SL BWP configuration) may also be excluded from the SL resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

In some embodiments, the duration of each SL frame and SL subframe is 10 milliseconds (ms) and 1 ms, respectively. The SL frames and SL subframes may include a numerology μ which may define the SCS, a number of slots in a subframe, and cyclic prefix options. In NR SL, the value of u ranges from 0 to 3. In addition, the supported u values vary at different frequency bands. In the frequency domain, the SCS may be defined by the numerology. In this regard, the SCS may be directly proportional to the numerology. Within the SL subframe, slots may be numbered from 0 to N subframe. In NR, given that different UE devices may operate in a different BWP and using a different numerology, a common resource block may be used for a device to locate frequency resources within the carrier bandwidth.

In some embodiments, the UE device may select resources in SL communication procedures with one or more BS devices and/or other UE devices. In one example, the UE device may obtain parameters for an SL communication procedure including resources selected from a portion of an unlicensed spectrum. The UE device may identify, in the parameters, an SL resource pool including two adjacent sets of SL resources and a guard band. The two adjacent sets of SL resources may be separated by the guard band. The guard band may include resources with the bandwidth in the portion of the unlicensed spectrum. The UE device may determine, based on the SL resource pool, a resource selection pattern for an SL transmission. In accordance with the resource selection pattern the UE device may perform a resource selection procedure including resources selected from the portion of the unlicensed spectrum.

In another example, the UE device may obtain parameters for an SL communication procedure including resources selected from a portion of an unlicensed spectrum. The bandwidth may include an SL resource pool including at least two adjacent resource sets and a multiple interlaces in each resource set. The UE device may determine, based on the SL resource pool, a resource selection pattern for an SL transmission. In accordance with the resource selection pattern, the UE device may perform a resource selection procedure including resources selected from the portion of the unlicensed spectrum.

### Example Communication Device

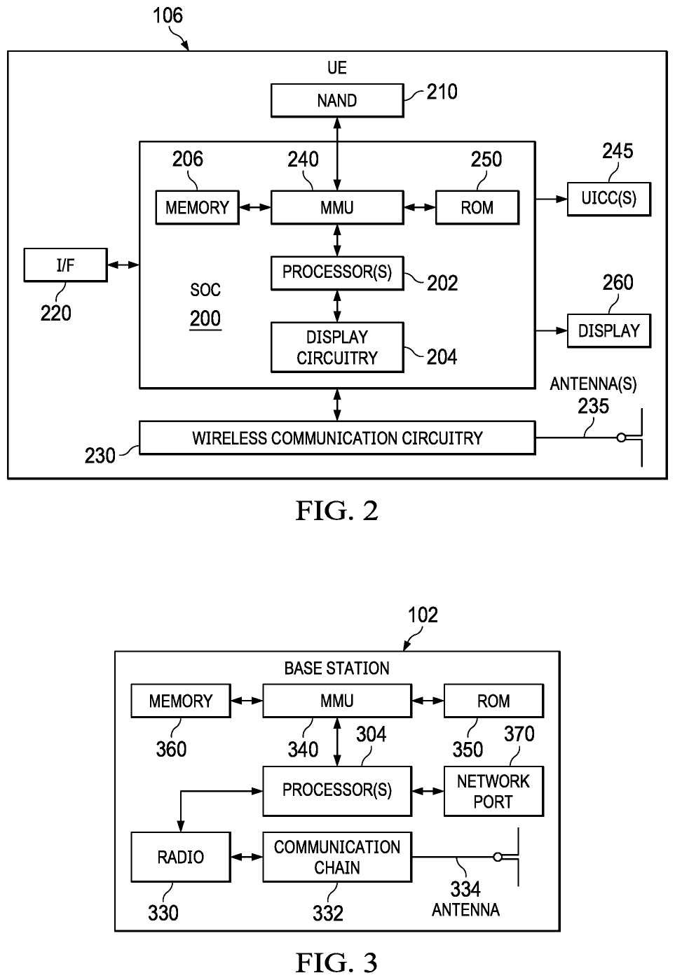

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mm Wave frequencies. As mmWave systems operate in higher frequencies than typically found in LTE systems, signals in the mm Wave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

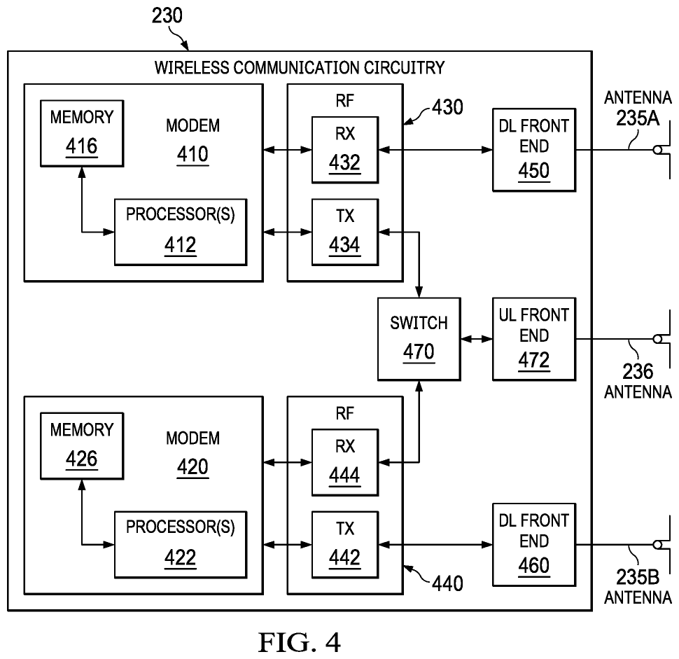

FIG. 3 illustrates an example block diagram of a base station 102, according to some aspects. It is noted that the base station of FIG. 3 is a non-limiting example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 304 of the base station 102 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

### Example Cellular Communication Circuitry

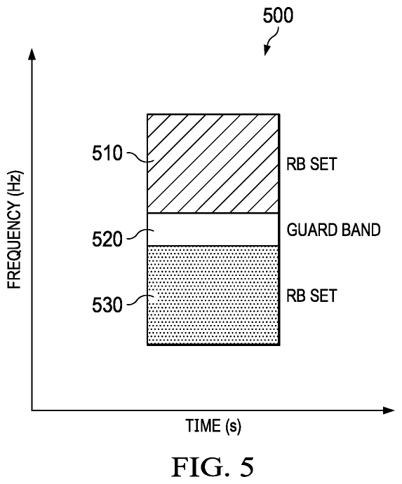

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 230 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 230 may couple (e.g., communicatively; directly or indirectly) to one or more antennas, such as antennas 235a, 235b, and 236 as shown. In some aspects, cellular communication circuitry 230 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 230 may include a first modem 410 and a second modem 420. The first modem 410 may be configured for communications according to a first RAT, e.g., such as LTE or LTE-A, and the second modem 420 may be configured for communications according to a second RAT, e.g., such as 5G NR.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some aspects, receive circuitry 432 may be in communication with downlink (DL) front end 450, which may include circuitry for receiving radio signals via antenna 235a.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some aspects, receive circuitry 442 may be in communication with DL front end 460, which may include circuitry for receiving radio signals via antenna 235b.

In some aspects, a switch 470 may couple transmit circuitry 434 to uplink (UL) front end 472. In addition, switch 470 may couple transmit circuitry 444 to UL front end 472. UL front end 472 may include circuitry for transmitting radio signals via antenna 236. Thus, when cellular communication circuitry 230 receives instructions to transmit according to the first RAT (e.g., as supported via the first modem 410), switch 470 may be switched to a first state that allows the first modem 410 to transmit signals according to the first RAT (e.g., via a transmit chain that includes transmit circuitry 434 and UL front end 472). Similarly, when cellular communication circuitry 230 receives instructions to transmit according to the second RAT (e.g., as supported via the second modem 420), switch 470 may be switched to a second state that allows the second modem 420 to transmit signals according to the second RAT (e.g., via a transmit chain that includes transmit circuitry 444 and UL front end 472).

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 450, 470, 472, 235 and 236 may be configured to implement part or all of the features described herein.

In addition, as described herein, processors 412, 422 may include one or more processing elements. Thus, processors 412, 422 may include one or more integrated circuits (ICs) that are configured to perform the functions of processors 412, 422. In addition, each integrated circuit may include circuitry (e.g., first circuitry, second circuitry, and the like) configured to perform the functions of processors 412, 422.

In some aspects, the cellular communication circuitry 230 may include only one transmit/receive chain. For example, the cellular communication circuitry 230 may not include the modem 420, the RF front end 440, the DL front end 460, and/or the antenna 235b. As another example, the cellular communication circuitry 230 may not include the modem 410, the RF front end 430, the DL front end 450, and/or the antenna 235a. In some aspects, the cellular communication circuitry 230 may also not include the switch 470, and the RF front end 430 or the RF front end 440 may be in communication, e.g., directly, with the UL front end 472.

### Example SL Communication Link Management

SL communication links may be used to help reduce interference and to help support a large number of wireless devices that are neighboring one another. The SL communication links effectively allows transmission and reception of SL transmissions. In some embodiments, the beams are representations of communication being shared between two wireless devices. These SL transmissions may be directed by each wireless device. In some embodiments, the SL transmissions with a predetermined direction may be referred to as beams. As the beams are directed toward a relatively small area as compared to a cell wide signal, a wireless node needs to know where a wireless device is located relative to the wireless node to allow the wireless node to direct beams toward the wireless device.

### Example of a Slot Structure

A slot structure of a radio frame in an SL transmission may include multiple different types of resources. In some embodiments, the resources are selected in a predetermined pattern including 10 PRBs/sub-channels. This predetermined pattern may be a configuration for implementing SL transmissions in 5G NR. The predetermined pattern may include resources selected for a PSCCH, a PSSCH, an automatic gain control (AGC) symbol, a GAP symbol, and a PSFCH symbol including AGC training. In the slot, the AGC symbol may be a copy of a next symbol. The AGC symbol may be used in the slot to automatically control an increase in an amplitude of the radio frame.

In the slot, the AGC symbol may be a first symbol in a slot for AGC training and a first sidelink symbol may be a copy of a second sidelink symbol. The PSCCH may be a channel configured for sidelink control information. The PSCCH may include SL control information (SCI) stage 1 with information related to resource selection in a first stage SCI A type as defined in TS 38.214 of the 3GPP standard. The PSCCH may start from the second symbol in the slot and may last 2 or 3 symbols in the time domain. The PSCCH may be pre-configured or dynamically assigned. The PSCCH may occupy several contiguous PRBs in the frequency domain. The PSCCH may be configured with candidate numbers including 10, 12, 15, 20, or 25 PRBs. The lowest PRB of the PSCCH is the same as the lowest PRB of the corresponding PSSCH. The PSSCH may be configured for sidelink data. The PSSCH may be configured to include a second stage SCI information about data transmission and feedback in SCI 2-A (e.g., unicast, groupcast, broadcast) and SCI 2-B (e.g., Groupcast) as defined in TS 38.214 of the 3GPP standard. The GAP symbol may be a symbol used for GAP (i.e., Tx/Rx switch) right after a PSSCH transmission. The PSFCH symbol may be configured for sidelink HARQ feedback. The slot may include a PSBCH that may be configured for sidelink broadcast information and an S-SSB for synchronization.

In some embodiments, the slot is included in an SL BWP. The slot may be part of an SL resource pool including a set of time-frequency resources for SL transmission and/or reception. The slot may be used in SL transmissions involving unicast, groupcast, and broadcast for a given UE device.

In 5G NR, the PSCCH and the PSBCH may include a DMRS reused for resource mapping and sequencing. Sidelink CSI-RS may be refined in the PSSCH. The sidelink CSI-RS configuration may be given by a PC5 interface, from the UE device transmitting the sidelink CSI-RS. Sidelink PTRS may be refined in the PSSCH. Further, in 5G NR, a UE device may be configured with one or more reference signal information elements, such as those described in TS 38.211, TS 38.214, and TS 38.331 of the 3GPP standard.

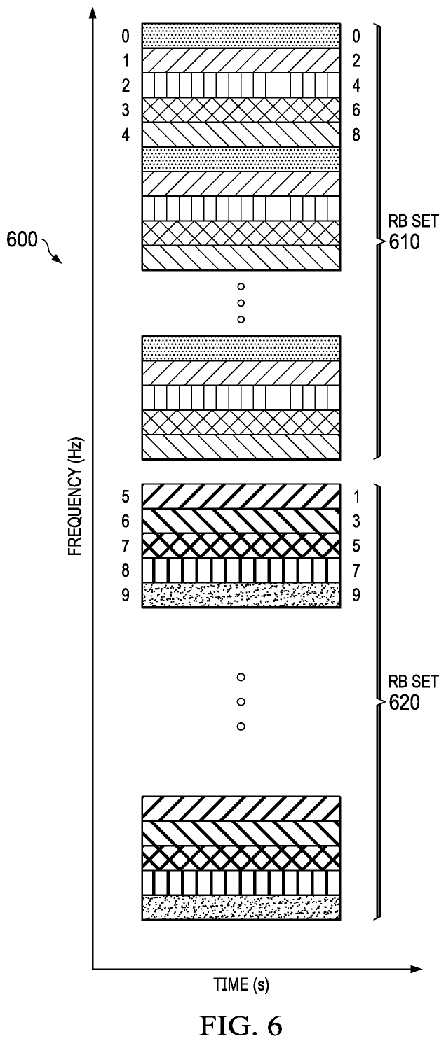

In one or more embodiments, a terminal may receive configuration parameters from a core network (e.g., a gNB) or may receive preconfigured parameters. The parameters may be definitions for one or more communication procedures. The parameters may include configuration information to implement an SL communication procedure including resources selected from a portion of an unlicensed spectrum. The terminal may be configured to determine, based on the parameters, a resource selection pattern for the SL communication procedure. The terminal may identify an SL resource pool in the parameters. The parameters may be information for allocating resources to one or more PRBs or information for indexing resources to one or more PRBs for a predetermined channel/sub-channel. The resource pool may be one of those described in detail in reference to FIGS. 5, 6, and 8A-10. These resource pools may include PRBs available for selection and/or indexing in one or more portions of an unlicensed spectrum in accordance with the resource selection pattern.

FIG. 5 is a diagram illustrating an example of an SL source pool 500, in accordance with one or more embodiments. In this example of FIG. 5, the SL resource pool 500 includes at least two adjacent RB sets 510 and 530 divided by a guard band 520. The guard band 520 may be an intra-cell guard band configured with PRBs in a portion of an unlicensed spectrum. As described above, the unlicensed spectrum may be frequencies in at least one individual unlicensed band in a bandwidth with a range between 4.1 gigahertz (GHz) and 7.125 GHz.

In the example of FIG. 5, the SL resource pool 500 includes PRBs that extend horizontally in a time domain (in seconds (s)) and extend vertically in a frequency range (in hertz (Hz)). In the vertical direction, the adjacent RB sets 510 and 530 are solely separated by the guard band 520. The adjacent RB sets 510 and 530 may be indexed one after the other. For example, a first RB set 510 may be an RB set identified with the value “i” and a second RB set 530 may be an RB set identified with the value “i+1.”

As shown in FIG. 5, two adjacent and subsequent RB sets 510 and 530 are divided by the guard band 520. In this case, PRBs within the guard band 520 may be defined as belonging to the SL resource pool 500 because the resource pool 500 includes two adjacent RB sets and an intra-cell guard band. In some embodiments, resources selected in the guard band 520 may belong to either the RB set 510 or the RB set 530.

As described above, the resource selection pattern may include instructions for allocating resources in the SL source pool 500. In the example of FIG. 5, the resource selection pattern may allow the terminal to perform a resource selection procedure including resources selected from two adjacent sets of SL resources (e.g., the RB sets 510 and 530) and multiple resources in the bandwidth including the portions of the unlicensed spectrum (e.g., the guard band 520).

In some embodiments, PRBs in the guard band 520 belong to one of the two adjacent RB sets 510 and 530. In this case, resources selected for the guard band 520 may be of a same type to those selected for the RB set 510 or the RB set 530. For example, the guard band 520 and at least one of the two adjacent RB sets 510 and 530 may include resources selected for a same communication channel such that a subset of resources selected for the guard band 520 may be associated with resources selected for the RB set 510 or the RB set 530. In this case, the resources selected for the portion of the unlicensed spectrum in the guard band 520 may belong to an RB set that is lower in index between the RB set 510 and the RB set 530 or to an RB set that is higher in index between the RB set 510 and the RB set 530.

In some embodiments, PRBs in the guard band 520 belong to both of the two adjacent RB sets 510 and 530. In this case, resources selected for the guard band 520 may be of a same type to those selected for the RB set 510 and the RB set 530. For example, the guard band 520 and the RB set 510 may include resources selected for a same communication channel such that a first subset of resources selected for the guard band 520 may be associated with resources selected for the RB set 510. Further, the guard band 520 and the RB set 530 may include resources selected for a same communication channel such that a second subset of resources selected for the guard band 520 may be associated with resources selected for the RB set 530. The guard band 520 may include the first subset, the second subset, and one or more additional subsets. In this case, a portion of the PRBs may belong to a specific RB set. The guard band 520 may be related to one of the RB sets 510 and 530 via a corresponding index in accordance with the resource selection pattern. For example, the resource selection pattern may indicate that PRBs in the guard band 520 are associated to the RB set with a low or a high index.

In some embodiments, PRBs in the guard band 520 do not belong to any of the two adjacent RB sets 510 and 530. In this case, resources selected for the guard band 520 may not be of a same type to those selected for the RB set 510 or the RB set 530. For example, the guard band 520 and both the two adjacent RB sets 510 and 530 may include resources selected for different communication channel such that resources selected for the guard band 520 are not associated with resources selected for the RB set 510 or the RB set 530.

The PRBs in the guard band 520 may be reserved for other purposes in accordance with the resource selection pattern. For example, these PRBs may be reserved for SL positioning, additional PSFCH transmissions, and the like. In some embodiments, the resource pool 500 may be configured in accordance with the resource selection pattern. If the resource pool 500 only includes two adjacent RB sets, PRBs in the guard band 520 may not be considered to belong to the resource pool 500. In this case, the SL transmission may include a bitmap configured to relate resources selected for the guard band 520 to a specific SL resource pool. In the bitmap, each bit may indicate a PRB selection. Further, the SL transmission may include a bit configured to indicate whether resources selected for the guard band are related to the specific SL resource pool. The specific SL resource pool may be a resource pool adjacent to the SL resource pool 500.

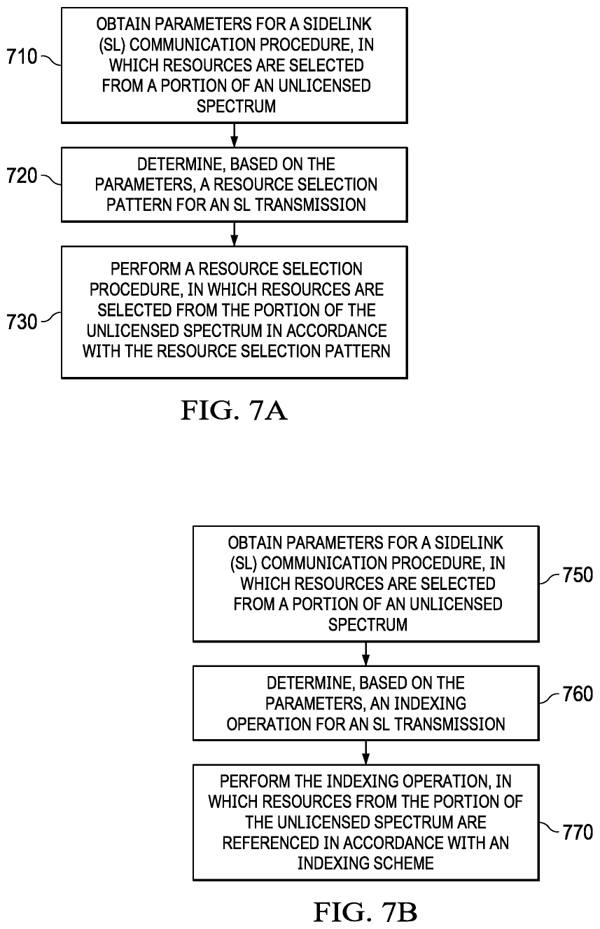

FIG. 6 is a diagram illustrating examples of two different indexing schemes applied to a same resource pool 600, in accordance with one or more embodiments. In the example FIG. 6, the SL resource pool 600 includes at least two adjacent RB sets 610 and 620. Different sub-channels are shown to be indexed at different rates in a first RB set 610 and a second RB set 620. The sub-channels may be configured with specific channel signals (e.g., PSCCH or PSSCH) in accordance with an indexing operation. The indexed sub-channels may include PRBs selected for portions of the unlicensed spectrum. The PRBs are shown as individual rectangles in the RB sets 610 and 620. As described above, the unlicensed spectrum may be frequencies in at least one individual unlicensed band in a bandwidth with a range between 4.1 gigahertz (GHz) and 7.125 GHz.

In FIG. 6, the indexed resources are shown in numbering located at a left size (e.g., from top to bottom: 0, 1, 2, 3, 4 . . . 5, 6, 7, 8, and 9) and at a right size (e.g., from top to bottom: 0, 2, 4, 6, 8 . . . 1, 3, 5, 7, and 9) of the first RB set 610 and the second RB set 620. The indexing scheme of the left size may include indexing multiple interlaces in sequence over adjacent resource sets. In this example, from top to bottom, PRBs are indexed in sequence and incrementing by one unit. The indexing scheme of the right side may include interleaving indexes of multiple interlaces over adjacent resource sets. In this example, from top to bottom, PRBs are indexed in by alternating between the RB set 610 and the RB set 620 and incrementing by one unit.

In the example of FIG. 6, the SL resource pool 600 includes PRBs that extend horizontally in a time domain (in seconds (s)) and extend vertically in a frequency range (in hertz (Hz)). In the vertical direction, the adjacent RB sets 610 and 620 may be indexed one after the other. For example, a first RB set 610 may be an RB set identified with the value “i” and a second RB set 620 may be an RB set identified with the value “i+1.”

As described above, the resource selection pattern may include instructions for allocating resources in the SL source pool 600. In the example of FIG. 6, the resource selection pattern may allow the terminal to perform a resource indexing procedure where resources are indexed to a set of SL resources in a sub-channel (e.g., one of the RB sets 610 and 620), which include multiple resources in the bandwidth including the portions of the unlicensed spectrum (e.g., indexed interlaces on either side of the resource pool 600). The resource selection pattern may include sub-channel indexes indicated in SCI (e.g., stage 1) to a predetermined decoding. The sub-channel may include at least one interlace per RB set.

In some embodiments, the resource selection pattern indicates indexing for the interlace first and the corresponding RB set second. As shown by the left side of FIG. 6, the interlaces are prioritized by the indexing in the resource selection pattern. Assuming that the interlace index is a value of A, the sub-channel index for the rest of one of the RB sets 610 and 620 may be defined as Sub-Channel Index=A+(B·C). In this equation, B is the RB set index and C is the total number of RB sets in the SL resource pool 600.

In some embodiments, the resource selection pattern indicates indexing for the corresponding RB set first and the interlace second. As shown by the right side of FIG. 6, the RB set resources are prioritized by the indexing in the resource selection pattern. Assuming that the interlace index is a value of A, the sub-channel index for the rest of one of the RB sets 610 and 620 may be defined as Sub-Channel Index=(A·D)+B. In this equation, B is the RB set index and D is the total number of interlaces in a given RB set in the SL resource pool 600.

In some embodiments, the resource selection pattern indicates independent indexing for the corresponding RB set and the interlace. In this case, the SCI may include two fields. A first field may include the RB set index A and a second field may include an interlace index B within an RB set. The resource selection pattern may provide a resource pool configuration to select between resource indexing procedures. Further, the resource pool configuration may be used in sub-channels including two or more interlaces within a single RB set. In this example, assuming that a same number of sub-channels are used for initial transmission and retransmission, stage 1 Sci may indicate a starting sub-channel index and a total number of sub-channels used for PSSCH transmissions.

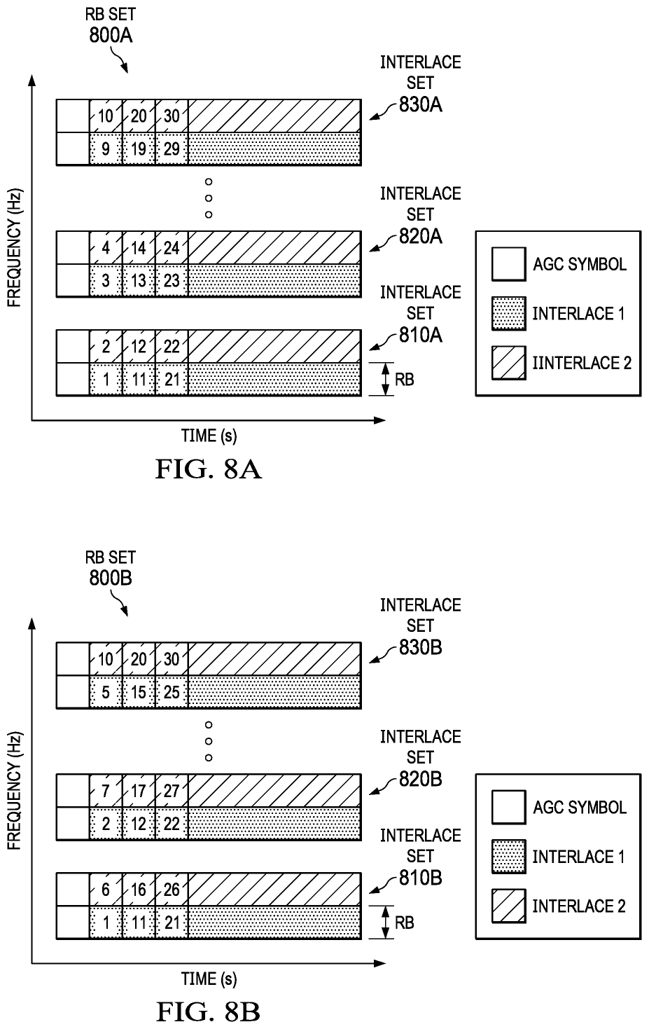

Turning to FIG. 7A, a flowchart is shown, detailing a method of allocating resources in an SL radio frame to be used for an SL communication procedure in accordance with one or more embodiments. In this example, the method is executed by a terminal exchanging information via SL communication links established with a base station and/or one or more neighboring terminals.

At 710, the flowchart begins with a terminal configured to obtain parameters for an SL communication procedure including resources selected from a portion of an unlicensed spectrum. The terminals may be UE devices configured to perform SL transmissions. The parameters may include information for enabling transmission of one or more SL procedures.

At 720, the flowchart continues with the terminal configured to determine, based on the parameters, a resource selection pattern for an SL transmission. The resource selection pattern may provide the terminal with multiple mapping instructions to select resources to RBs in the unlicensed spectrum. In some embodiments, the terminal may identify, in the parameters, an SL resource pool including two adjacent sets of SL resources and a guard band. The two adjacent sets of SL resources being separated by the guard band. The guard band may include the bandwidth including the portion of the unlicensed spectrum.

The flowchart ends at 730 where the terminal is configured to perform a resource selection procedure including resources selected from the portion of the unlicensed spectrum in accordance with the resource selection pattern. In some embodiments, a subset of resources selected for the guard band may be associated with resources selected for one set of SL resources out of the two adjacent sets of SL resources.

Turning to FIG. 7B, a flowchart is shown, detailing a method of determining an indexing operation in an SL communication procedure in accordance with one or more embodiments. In this example, the method is executed by a terminal exchanging information via SL communication links established with a base station and/or one or more neighboring terminals. In some cases, resources selected for the guard band include a first subset of SL resources and a second subset of SL resources. The first subset of SL resources may be associated with resources selected for a first set of SL resources out of the two adjacent sets of SL resources. The second subset of SL resources is associated with resources selected for a second set of SL resources out of the two adjacent sets of SL resources.

At 750, the flowchart begins with a terminal configured to obtain parameters for an SL communication procedure including resources selected from a portion of an unlicensed spectrum. The terminals may be UE devices configured to perform SL transmissions. The parameters may include information for enabling transmission of one or more SL procedures. In some embodiments, resources selected for the guard band may not be associated with resources selected for any of the two adjacent sets of SL resources.

At 760, the flowchart continues with the terminal configured to determine, based on the parameters, an indexing operation for an SL transmission. The indexing operation may provide the terminal with multiple mapping instructions to map resources to RBs in the unlicensed spectrum.

The flowchart ends at 770 where the terminal is configured to perform the indexing operation including resources selected from the portion of the unlicensed spectrum are references in accordance with an indexing scheme. At this stage, the terminal performs the indexing operation based on the indexing scheme in the manner described above in reference to FIG. 6. The indexing scheme may include instructions for mapping indexed resources throughout a resource pool.

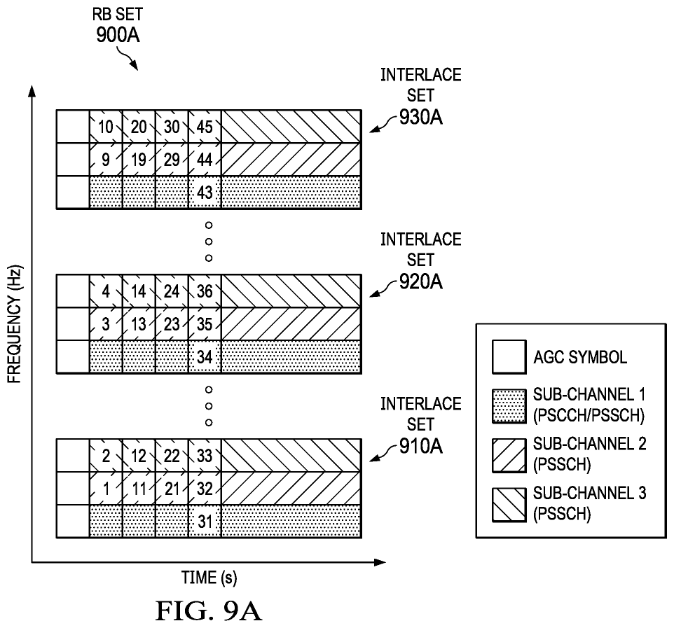

FIGS. 8A and 8B illustrate examples of two frame configurations, in accordance with one or more embodiments. In the examples of FIGS. 8A and 8B, the RB sets 800A and 800B include RBs that extend horizontally in a time domain (in seconds(s), slot(s)) and extend vertically in a frequency range (in hertz (Hz)). In the RB sets 800A and 800B, the PSCCH may be mapped to the first two or three symbols (after the AGC symbol) in a single sub-channel. In FIGS. 8A and 8B, frames may be configured for the PSCCH in accordance with preconfigured (e.g., configured from factory settings) or dynamically configured (e.g., configured from the core network via a BS device or a UE device) parameters. In the case of an SL resource pool preconfiguration, the PSCCH may occupy one or more continuous interlaces within one or more RB sets and/or part of an interlace within a single RB set. In some embodiments, the PSCCH may be mapped to occupy one or more continuous interlaces within an RB set when the single sub-channel occupies one or more continuous interlaces.

FIG. 8A shows three separate interlace sets 810A-830A in the RB set 800A. Each interlace in each interlace set includes an AGC symbol which may be a copy of a next symbol. The AGC symbol may be used in the slot to automatically control an increase in an amplitude of each radio frame. In the example of FIG. 8A, frequency resources are first mapped in the single sub-channel before time resources. Each interlace set includes indexed resources for interlaces 1 and 2. In the interlace set 810A, interlace 1 includes resources indexed with numbers 1, 11, and 21 and interlace 2 includes resources indexed with numbers 2, 12, and 22. In the interlace set 820A, interlace 1 includes resources indexed with numbers 3, 13, and 23 and interlace 2 includes resources indexed with numbers 4, 14, and 24. In the interlace set 830A, interlace 1 includes resources indexed with numbers 9, 19, and 29 and interlace 2 includes resources indexed with numbers 10, 20, and 30. The interlace sets 810A-830A in the RB set 800A increase indexing by one unit combining both interlaces as the values of frequency increase at a given time.

In some embodiments, if the PSCCH is mapped to occupy a part of an interlace within a single RB set and the sub-channel includes one interlace, then the PSCCH may be mapped to the lowest RB in the interlace of the sub-channel. If the PSCCH is mapped to occupy a part of an interlace within a single RB set and the sub-channel includes multiple interlaces, then the PSCCH may be mapped to the lowest RB in a given interlace of the sub-channel. In this case, the mapping information may indicate mapping of the PSCCH in the lowest resource in the at least one interlace after additional frequency resources in the sub-channel. Alternatively, the mapping information may indicate mapping of the PSCCH in the lowest resource in the at least one interlace before additional frequency resources in the sub-channel.

FIG. 8B shows three separate interlace sets 810B-830B in the RB set 800B. Each interlace in each interlace set includes an AGC symbol which may be a copy of a next symbol. In the example of FIG. 8B, individual interlaces are first mapped in the single sub-channel before time resources. Each interlace set includes indexed resources for interlaces 1 and 2. In the interlace set 810B, interlace 1 includes resources indexed with numbers 1, 11, and 21 and interlace 2 includes resources indexed with numbers 6, 16, and 26. In the interlace set 820B, interlace 1 includes resources indexed with numbers 2, 12, and 22 and interlace 2 includes resources indexed with numbers 7, 17, and 27. In the interlace set 830B, interlace 1 includes resources indexed with numbers 5, 15, and 25 and interlace 2 includes resources indexed with numbers 10, 20, and 30. The interlace sets 810B-830B in the RB set 800B increase indexing by one unit for each individual interlace as the values of frequency increase at a given time.

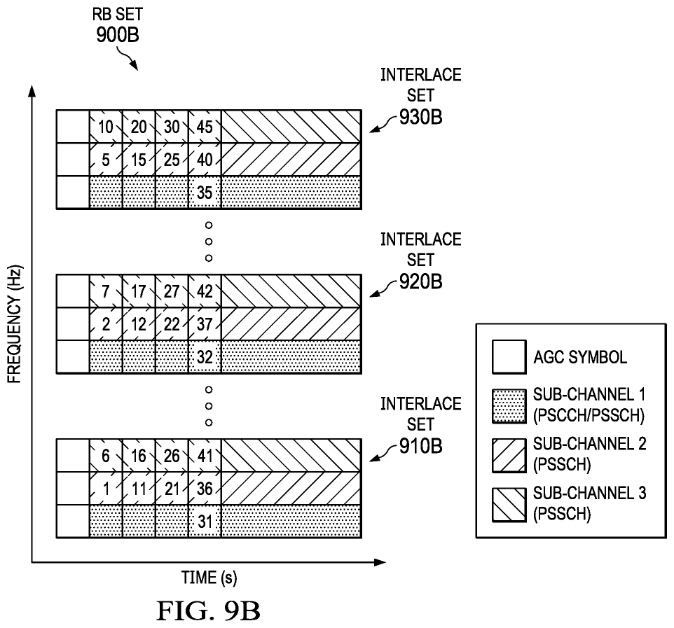

FIGS. 9A and 9B illustrate examples of two frame configurations, in accordance with one or more embodiments. In the examples of FIGS. 9A and 9B, the RB sets 900A and 900B include RBs that extend horizontally in a time domain (in seconds (s)) and extend vertically in a frequency range (in hertz (Hz)). In the RB sets 900A and 900B, the PSCCH may be mapped to the first two or three symbols (after the AGC symbol) while the PSSCH is mapped to one or more remaining symbols in a single sub-channel. A first sub-channel may be used to at least partially map the PSCCH (e.g., sub-channel 1 (PSCCH/PSSCH)) while subsequent sub-channels may be used to map the PSSCH (e.g., sub-channel 2 (PSSCH) and sub-channel 3 (PSSCH)). In FIGS. 9A and 9B, frames may be configured for the PSSCH in accordance with preconfigured (e.g., configured from factory settings) or dynamically configured (e.g., configured from the core network via a BS device or a UE device) parameters. In an SL transmission, contiguous interlaces may be mapped over a single RB set or two adjacent (e.g., neighboring) RB sets.

FIG. 9A shows three separate interlace sets 910A-930A in the RB set 900A. Each interlace in each interlace set includes an AGC symbol. In the example of FIG. 9A, frequency resources are first mapped over the sub-channels before time resources. Each interlace set includes indexed resources for sub-channels 1-3. In the interlace set 910A, sub-channel 1 includes resources indexed with number 31, sub-channel 2 includes resources indexed with numbers 1, 11, 21, and 32, and sub-channel 3 includes resources indexed with numbers 2, 12, 22, and 33. In the interlace set 920A, sub-channel 1 includes resources indexed with number 34, sub-channel 2 includes resources indexed with numbers 3, 13, 23, and 35, and sub-channel 3 includes resources indexed with numbers 4, 14, 24, and 36. In the interlace set 930A, sub-channel 1 includes resources indexed with number 43, sub-channel 2 includes resources indexed with numbers 9, 19, 29, and 44, and sub-channel 3 includes resources indexed with numbers 10, 20, 30, and 45. The interlace sets 910A-930A in the RB set 900A increase indexing by one unit combining all interlaces as the values of frequency increase at a given time.

FIG. 9B shows three separate interlace sets 910B-930B in the RB set 900B. Each interlace in each interlace set includes an AGC symbol. In the example of FIG. 9B, individual interlaces are first mapped in the single sub-channel and then a next sub-channel before time resources. Each interlace set includes indexed resources for sub-channels 1-3. In the interlace set 910B, sub-channel 1 includes resources indexed with number 31, sub-channel 2 includes resources indexed with numbers 1, 11, 21, and 36, and sub-channel 3 includes resources indexed with numbers 6, 16, 26, and 41. In the interlace set 920B, sub-channel 1 includes resources indexed with number 32, sub-channel 2 includes resources indexed with numbers 2, 12, 22, and 37, and sub-channel 3 includes resources indexed with numbers 7, 17, 27, and 42. In the interlace set 930B, sub-channel 1 includes resources indexed with number 35, sub-channel 2 includes resources indexed with numbers 5, 15, 25, and 40, and sub-channel 3 includes resources indexed with numbers 10, 20, 30, and 45. The interlace sets 910B-930B in the RB set 900B increase indexing by one unit for each individual interlace as the values of frequency increase at a given time.

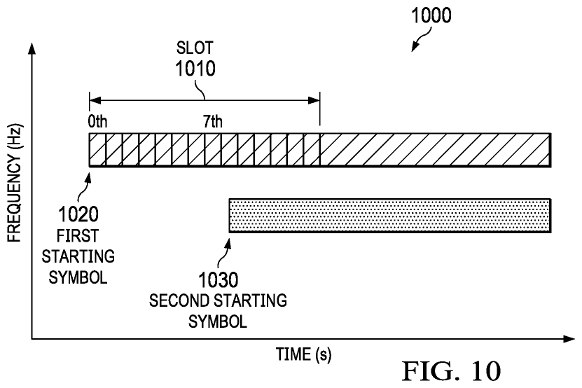

FIG. 10 illustrates an example of an SL transmission 1000 in accordance with one or more embodiments. The SL transmission 1000 includes multiple starting symbols within a starting time of a single slot. The SL transmission 1000 includes PRBs that extend horizontally in a time domain (in seconds (s)) and extend vertically in a frequency range (in hertz (Hz)). The SL transmission 1000 includes a slot 1010 with a first starting symbol 1020 and a second starting symbol 1030. In this figure, the first starting symbol 1020 and the second starting symbol 1030 start within the duration of the slot 1010.

In one or more embodiments, if the slot 1010 includes more than one starting symbol for PSCCH/PSSCH, then the PSCCH is expected to have two symbols. If the PSCCH occupies 3 symbols in the mapped indexes, then only one symbol is expected within the slot 1010 for PSCCH/PSSCH. In some embodiments, a gap between two potential starting symbols within a slot may be larger than or equal to a number X of symbols. The number X of symbols may be preconfigured or dynamically configured for a given SL transmission. In other embodiments, if a slot includes more than one starting symbol for PSCCH/PSSCH, then a total number of symbols in the slot for the SL transmission may be larger than or equal to a number Y of symbols. If an SL slot includes less than the number Y of symbols, then only a single starting symbol may be configured for PSCCH/PSSCH within a slot.

In some embodiments, if more than one starting symbol is configured within a slot for PSCCH/PSSCH, then the 0^{th} and the 7^{th} symbols may be considered as the starting symbols in the slot. If more than one starting symbol is configured for PSCCH/PSSCH within a slot, then a cross-slot consecutive transmission may be applied when the starting symbol is not at the beginning of the slot. In this case, the SL transmission 1000 may be configured to keep the total number of PSCCH decoding unchanged.

A terminal may perform multiple SL operations to decode the SL transmission 1000 including multiple starting symbols with resources selected in the unlicensed spectrum. For example, the terminal may try to decode the PSCCH at the beginning of a first slot. If the terminal decodes some PCCH at the beginning of the first slot (i.e., at the Oth symbol in the first slot), then the terminal may continue decoding the PSCCH at the beginning of the next slot (e.g., a second slot). Otherwise, the terminal may try to decode the PSCCH in the middle of the slot (i.e., at the 7^{th} symbol in the first slot). If the terminal decodes some PSCCH in the middle of the slot, then the terminal may continue to decode the PSCCH at the beginning of a third slot. Otherwise, the terminal may decode the PSCCH at the beginning of the next slot (e.g., the second slot).

The terminal receiving multiple symbols in the SL transmission may skip the decoding of the PSCCH at the beginning of the second slot. In some embodiments, an SCI decoded in the middle of the first slot may indicate to the terminal the frequency resource reservation on the first and the second slots. In this case, the time gap between two reserved resources may be based on the second slot in a cross-slot consecutive transmission. An SL transport block size (TBS) calculation may be based on the resources over both slots. Under these conditions, retransmission procedures may only occur at the beginning of a slot. In some embodiments, PSSCH DMRS time-domain locations may be extended to accommodate the terminal transmitting/receiving the SL transmission with the multiple starting symbols. These decoding locations may be extended as shown on TS 38.211 of the 3GPP standard, where Table 8.4.1.1.2-1 shows that symbols may be extended beyond the 13^{th} symbol.

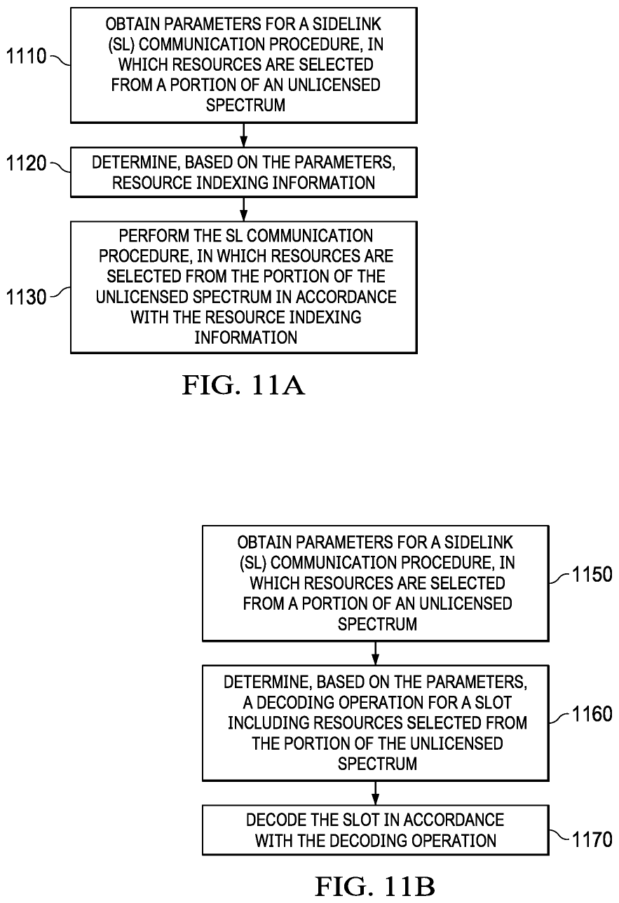

Turning to FIG. 11A, a flowchart is shown, detailing a method of indexing resources in an SL radio frame to be used for an SL communication procedure in accordance with one or more embodiments. In this example, the method is executed by a terminal exchanging information via SL communication links established with a base station and/or one or more neighboring terminals.

At 1110, the flowchart begins with a terminal configured to obtain parameters for an SL communication procedure including resources selected from a portion of an unlicensed spectrum. As described above, a resource pool may include resources selected for the unlicensed spectrum.

At 1120, the flowchart continues where the terminal determines, based on the parameters, resource indexing information. The terminal may map indexed resources for sub-channels in the manner described in reference to FIGS. 8A-10. The channel configuration information may provide the terminal with multiple selection instructions to map frequency resources to sub-channels in the unlicensed spectrum.

In some embodiments, the resource indexing information includes indexing of resources associated to a Physical Sidelink Control Channel (PSCCH). In other embodiments, the resource indexing information includes indexing of resources associated to a Physical Sidelink Shared Channel (PSSCH). In these cases, the resource indexing information includes indexing of resources over interleaving interlaces on a same symbol such that indexing increases as a frequency range increases over multiple interlaces. Further, the resource indexing information may include indexing of resources over a first interlace followed by a second interlace on a same symbol such that indexing increases over a same interlace in the frequency range before switching to another interlace on the same frequency range. In other embodiments, the resource indexing information includes indexing of a lowest available number resource when a number of indexed resources is less than a number of resources available in a given symbol.

The flowchart ends at 1130, where the terminal is configured to perform the SL communication procedure including resources selected from the portion of the unlicensed spectrum in accordance with the resource indexing information.

Turning to FIG. 11B, a flowchart is shown, detailing a method of decoding a portion of an SL radio frame to be used for an SL communication procedure in accordance with one or more embodiments. In this example, the method is executed by a terminal exchanging information via SL communication links established with a base station and/or one or more neighboring terminals.

At 1150, the flowchart begins with a terminal configured to obtain parameters for an SL communication procedure including resources selected from a portion of an unlicensed spectrum.

At 1160, the flowchart continues where the terminal determines, based on the parameters, a decoding operation for a slot including resources selected for the bandwidth including the portion of the unlicensed spectrum. The slot may include multiple starting symbols within the slot. This slot may be a first slot out of multiple slots including the multiple starting symbols.

The flowchart ends at 1170, where the terminal decodes the slot in accordance with the decoding operation. In some embodiments, the terminal tries to decode a resource selected for a Physical Sidelink Control Channel (PSCCH) at the beginning of the slot. In some embodiments, the terminal may continue to decode the PSCCH at the beginning of a second slot when some PSCCH is decoded at the beginning of the first slot. In other embodiments, the terminal may decode the PSCCH in the middle of the first slot when no PSCCH is decoded at the beginning of the first slot. Further, the terminal may be configured to continue to decode the PSCCH at the beginning of a third slot when some PSCCH is decoded at the middle of the first slot. The terminal may decode the PSCCH at the beginning of a second slot when no PSCCH is decoded at the middle of the first slot

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A terminal, comprising:
a receiver configured to receive one or more SL transmissions; and
a processor configured to:
obtain parameters for a sidelink (SL) communication procedure that includes resources selected from a portion of an unlicensed spectrum,
identify, in the parameters, an SL resource pool including two adjacent sets of SL resources and a guard band, the two adjacent sets of SL resources being separated by the guard band, the guard band comprising the bandwidth including the portion of the unlicensed spectrum,
determine, based on the SL resource pool, a resource selection pattern for an SL transmission, and
perform a resource selection procedure that includes resources selected from the portion of the unlicensed spectrum in accordance with the resource selection pattern.

2. The terminal of claim 1, wherein:
a subset of resources selected for the guard band are associated with resources selected for one set of SL resources out of the two adjacent sets of SL resources.

3. The terminal of claim 1, wherein:
a plurality of resources selected for the guard band include a first subset of SL resources and a second subset of SL resources,
the first subset of SL resources is associated with resources selected for a first set of SL resources out of the two adjacent sets of SL resources, and
the second subset of SL resources is associated with resources selected for a second set of SL resources out of the two adjacent sets of SL resources.

4. The terminal of claim 1, wherein:
resources selected for the guard band are not associated with resources selected for any of the two adjacent sets of SL resources.

5. The terminal of claim 1, wherein:
the resource selection procedure includes a bitmap relating resources selected for the guard band to the SL resource pool.

6. The terminal of claim 1, wherein:
the resource selection procedure includes a single bit relating resources selected for the guard band to the SL resource pool.

7. A terminal, comprising:
a receiver configured to receive one or more SL transmissions; and
a processor configured to:
obtain parameters for a sidelink (SL) communication procedure that includes resources selected from a portion of an unlicensed spectrum, the bandwidth comprising an SL resource pool including a plurality of adjacent resource sets and a plurality of interlaces in each resource set;
determine, based on the SL resource pool, an indexing operation for an SL transmission, and
perform the indexing operation that includes resources selected from the portion of the unlicensed spectrum referenced in accordance with an indexing scheme.

8. The terminal of claim 7, wherein:
the indexing operation includes indexing the plurality of interlaces in sequence over adjacent resource sets.

9. The terminal of claim 7, wherein:
the indexing operation includes interleaving indexes the plurality of interlaces over adjacent resource sets.

10. The terminal of claim 7, wherein:
the indexing operation includes indexing the plurality of interlaces and the plurality of adjacent resource sets.

11. A method comprising
receiving one or more SL transmissions;
obtaining parameters for a sidelink (SL) communication procedure that includes resources selected from a portion of an unlicensed spectrum,
identifying, in the parameters, an SL resource pool including two adjacent sets of SL resources and a guard band, the two adjacent sets of SL resources being separated by the guard band, the guard band comprising the bandwidth including the portion of the unlicensed spectrum,
determining, based on the SL resource pool, a resource selection pattern for an SL transmission, and
performing a resource selection procedure that includes resources selected from the portion of the unlicensed spectrum in accordance with the resource selection pattern.

12.-16. (canceled)

17. The method of claim 11, wherein:
a subset of resources selected for the guard band are associated with resources selected for one set of SL resources out of the two adjacent sets of SL resources.

18. The method of claim 11, wherein:
a plurality of resources selected for the guard band include a first subset of SL resources and a second subset of SL resources,
the first subset of SL resources is associated with resources selected for a first set of SL resources out of the two adjacent sets of SL resources, and
the second subset of SL resources is associated with resources selected for a second set of SL resources out of the two adjacent sets of SL resources.

19. The method of claim 11, wherein:
resources selected for the guard band are not associated with resources selected for any of the two adjacent sets of SL resources.

20. The method of claim 11, wherein:
the resource selection procedure includes a bitmap relating resources selected for the guard band to the SL resource pool.

21. The method of claim 11, wherein:
the resource selection procedure includes a single bit relating resources selected for the guard band to the SL resource pool.

22. The method of claim 11, wherein the bandwidth comprising the SL resource pool including a plurality of adjacent resource sets and a plurality of interlaces in each resource set, the method further comprising:
determining, based on the SL resource pool, an indexing operation for an SL transmission, and
performing the indexing operation that includes resources selected from the portion of the unlicensed spectrum referenced in accordance with an indexing scheme.

23. The method of claim 22, wherein:
the indexing operation includes indexing the plurality of interlaces in sequence over adjacent resource sets.

24. The method of claim 22, wherein:
the indexing operation includes interleaving indexes the plurality of interlaces over adjacent resource sets.

25. The method of claim 22, wherein:
the indexing operation includes indexing the plurality of interlaces and the plurality of adjacent resource sets.
